(19) United States
(12) Patent Application Publication
(10) Pub. No.: US 2026/0367220 A1
(43) Pub. Date: Nov. 19, 2026

(54) INTERFACE WITH INTEGRATED RADAR PROCESSING LOGIC

(71) Applicant: NVIDIA Corporation, Santa Clara, CA (US)

(72) Inventors: Romain Ygnace, Munich (DE); Thomas Joseph Tomazin, Austin, TX (US)

(21) Appl. No.: 19/206,537

(22) Filed: May 13, 2025

(51) Int. Cl. G01S 7/35; G01S 13/58; G01S 13/931

(52) U.S. Cl. CPC G01S 7/356; G01S 13/584; G01S 13/931

(57) ABSTRACT

A radar system includes a first radar sensor unit configured to generate radar data based on observed return signals. The radar system also includes memory. The radar system also includes a receiver coupled to the memory and the first radar sensor unit, the receiver includes an interface to receive the radar data from the first radar sensor unit, radar processing circuitry closely integrated with the interface to process the radar data into a first range fast Fourier transform (FFT), and one or more direct memory access (DMA) engines to write the first range FFT into the memory.

### TECHNICAL FIELD

At least one embodiment pertains to radar system partitioning.

### BACKGROUND

Radar systems can be designed with multiple radar heads positioned around a vehicle or platform, all connected to a central computing unit (also referred to as a central compute cluster). Each radar head is responsible for sending out radar waves and collecting the signals that bounce back from nearby objects. Instead of handling all the data processing on their own, the radar heads send this information to the central computer, which puts everything together to detect objects, measure distances, and track movement. This type of setup is an example of radar system partitioning, where the work is split between the radar heads that gather the data and a central unit that does the heavy processing. It allows the system to be more flexible and efficient, especially when covering wide areas or combining data from different locations.

### BRIEF DESCRIPTION OF THE DRAWINGS

FIG. 1A illustrates a radar system with radar accelerator logic closely integrated with an interface within a receiver of a central compute cluster, according to one embodiment.

FIG. 1B illustrates the radar system implemented within an automotive application, according to one embodiment.

FIG. 2 illustrates a processing pipeline for generating range FFTs using radar accelerator logic integrated within a receiver, according to one embodiment.

FIG. 3 illustrates a method of generating range FFTs without writing raw radar data to memory, according to one embodiment.

FIG. 4 illustrates a method of generating range FFTs without writing raw radar data to memory, according to one embodiment.

FIG. 5A illustrates an example communication system with devices that includes hybrid LT logic, in accordance with at least some embodiments.

FIG. 5B illustrates a block diagram of an example communication system that includes hybrid LT logic, according to at least one embodiment.

FIG. 6 illustrates an example computer system including a spectrum hardware engine and an error correction block according to at least one embodiment.

FIG. 7 is a block diagram of a computing system having two processing devices coupled to each other and multiple networks according to at least one embodiment.

FIG. 8 is a block diagram of a computing system having a central processing unit (CPU) and a graphics processing unit (GPU) in a single integrated circuit according to at least one embodiment.

FIG. 9 is a block diagram of a computing system having tensor core graphics processing units (GPUs) according to at least one embodiment.

### DETAILED DESCRIPTION

A key trend in automotive radar processing is centralizing it to a central compute cluster (also referred to as central electrical control unit (ECU)) where the advanced driver assistance system (ADAS) stack resides. The shift is driven by the limitations of radar processing at the edges of an automobile, where radar ECUs are typically deployed. Radar transceivers are usually placed behind the car's bumper, which suffers from poor air flow and lacks liquid cooling. Radar ECU casings are often plastic to cut costs, worsening thermal issues. As radar technology advances with higher resolution and more antenna channels, local processing at the radar ECU becomes harder.

However, pushing raw radar data to the central ECU introduces new processing challenges. Multiple radar ECUs can generate substantial data, overwhelming the central ECU's bandwidth. For example, one 4Rx-channel radar ECUs may generate approximately 3.2 Gbps of raw radar data. If an automobile is equipped with five such radar EDUs, the total data rate pushed toward the central ECU could reach approximately 16 Gbps or more of raw radar data. Handling this volume of radar data can be tough due to real-time processing latency, higher power consumption, thermal dissipation, and scalability issues as the number of sensors increases.

In conventional radar data processing pipelines, raw radar data from multiple EDUs is first stored in memory before being processed. A conventional radar data processing pipeline can typically include the following steps:
(1) transferring the raw radar data to memory,
(2) retrieving the raw radar data from the memory for radar processing, and
(3) writing the processed radar data to memory.

This conventional approach can result in both raw and processed radar data being concurrently written to memory, which places significant pressure on memory subsystems and direct memory access (DMA) systems. In general, the raw radar data is conventionally written to memory because local or on-chip buffers cannot handle the large volume of raw radar data being aggregated before it is processed, and thus is buffered in memory before the central ECU can retrieve it to perform fast Fourier Transforms (FFTs) or other radar processing steps. Additionally, the high volume of memory transactions performed by such a conventional radar processing pipeline can create contention at the memory controller, further exacerbating power latency and limiting overall processing efficiency.

Aspects and embodiments of the present disclosure address the above challenges and others by closely integrating radar accelerator logic with a data interface within a receiver of a central ECU that receives raw radar data from one or more radar heads. By doing so, the raw radar data may be processed using the radar accelerator logic without the raw radar data ever being transferred to memory of the central ECU. Instead, raw radar data may be processed into range FFTs before ever being written to memory.

According to embodiments, upon the receiver receiving the raw radar data, the raw radar data is stored within an intermediate buffer until raw radar data of an entire radar transmit sequence (e.g., one chirp) is received. The raw radar data of the radar transmit sequence is then processed into a range FFT, which is written to the memory of the central ECU (e.g., central EDU System on chip (SoC)) by a direct memory access (DMA) engine. Processing of the raw radar data into a range FFT may also include windowing, statistical analysis, or the like. Once all raw radar data of a radar cycle has been processed into range FFTs, these range FFTs may be retrieved from memory and be processed into a Doppler FFT using the radar accelerator logic. This Doppler FFT may then analyzed or otherwise processed by other components of the central ECU (e.g., ADAS stack, tracking algorithms, or the like).

By eliminating the transfer of raw radar data to memory, the radar processing flow is significantly enhanced. The pressure of both raw and processed radar data being concurrently written to memory is eliminated or at least greatly reduced. This reduction in memory transactions increases processing efficiency and reduces power consumption. Consequently, bus contention and power consumption is minimized, leading to a more efficient and streamlined radar system. Additionally, the simplified processing flow has decreased power latency compared to conventional radar processing pipelines.

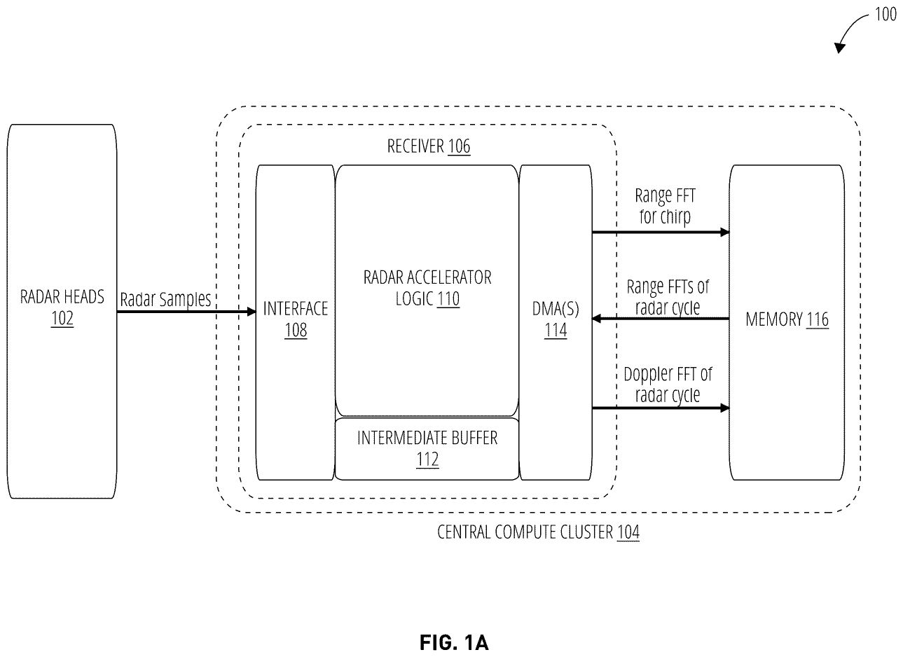

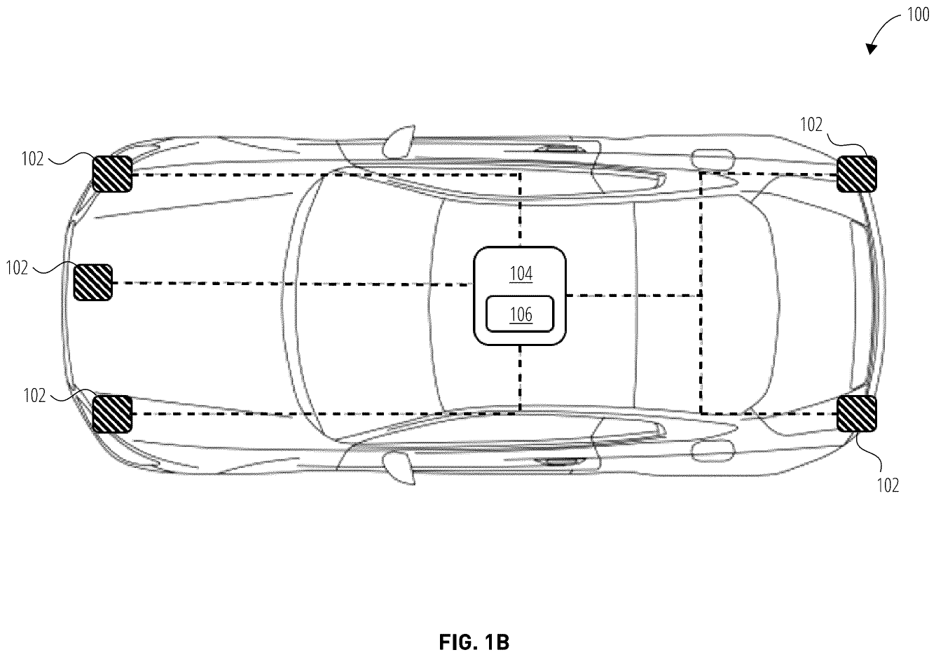

FIG. 1A illustrates a radar system 100 with radar accelerator logic 110 closely integrated with an interface 108 within a receiver 106 of a central compute cluster 104, according to one embodiment. According to embodiments, the receiver 106 may be a media access controller (MAC) configured to receive raw radar data from multiple radar heads 102 (sometimes referred to as radar sensor units) using Ethernet technologies or techniques via the interface 108. In other embodiments, the receiver 106 may be a camera serial interface (CSI) (e.g., MIPI CSI-2 interface) configured to receive raw radar data from the multiple radar heads 102 using CSI technologies or techniques via the interface 108. The receiver 106 may also include an intermediate buffer 112 that is capable of storing raw radar data as it is received from the radar heads 102. One or more DMA engines 114 may be capable of writing and retrieving (e.g., reading) sets of processed radar data, such as a range FFT or Doppler FFT, to memory 116 of the central compute cluster 104.

The radar heads 102 may be the primary sensors in the radar system 100. According to embodiments, the radar heads 102 may be a type of radar sensor unit that includes radar front-end (RFE) circuitry and an analog-to-digital converter (ADC). The radar head 102 may be responsible for generating raw radar data. The raw radar data may include radar samples that represent reflections of emitted radar waves from objects detected within the field of view (FOV) of the radar head 102. In some embodiments, one or more of the radar heads 102 may be transceivers that are capable of both emitting radar waves and subsequently observing their reflections. In at least one embodiment, the one or more of the radar heads 102 may only be capable of observing the reflections of radar waves emitted by other transmitter radar heads (not illustrated) of the radar system 100.

The radar heads 102 may include a variety of analog and digital hardware components configured to observe return signals reflected by objects in the environment and/or emit radar signals corresponding to those return signals. On the transmit side (if the radar heads 102 are configured to emit radar waves), the radar head 102 may include a waveform generator, such as a voltage-controlled oscillator (VCO) or phase-locked loop (PLL), configured to produce modulated radar waveforms (e.g., FMCW chirps or pulsed signals). This waveform may be amplified by a power amplifier (PA) and routed through a transmit/receive (T/R) switch or circulator to a radar antenna. The antenna may be implemented as a patch array, planar array, phased array structure, or any other suitable structure, and may be responsible for radiating the modulated signal into free space.

On the receive side, the radar head 102 may include one or more antennas configured to collect reflected signals, which may be downconverted to an intermediate frequency (IF) or baseband by a mixer circuit using a local oscillator (LO) signal derived from the same waveform generator (or a waveform generator producing a same or similar waveform). The downconverted signal may be filtered by a low-pass or band-pass filter to remove out-of-band noise and amplified by a low-noise amplifier (LNA). The filtered analog signal may then be digitized using a high-speed analog-to-digital converter (ADC). These may be referred to as ADC samples, radar samples, or raw radar data. The radar heads 102 may also include signal conditioning blocks, such as Variable Gain Amplifiers (VGAs), automatic gain control (AGC) circuits, or temperature compensation units.

The radar system 100 may utilize any suitable type of radar wave, commonly referred to as transmit sequences. One of the more prevalent types of radar waves used in automotive radar systems is a Frequency Modulated Continuous Wave (FMCW) chirp (also referred to herein as a chirp). A chirp is a radar signal in which the frequency increases or decreases over a set period. This modulation can allow the radar system 100 to measure both distance and relative velocity of objects by analyzing the frequency shift of the returned signal (i.e., observed reflections). The radar system 100 may cause a series of these chirps to be transmitted over a radar cycle, which are then reflected off objects and received back by the radar system 100 via the radar heads 102.

As used herein, a radar cycle includes a predetermined number of these transmit sequences. While descriptions herein of the present disclosure may use chirps as an example, any transmit sequence suitable for radar processing may be utilized. Each radar cycle may be designed to capture a comprehensive snapshot of the environment by emitting multiple chirps in quick succession. Each successively transmitted chirp may be identical or may each have a slightly different frequency modulation. For example, a radar cycle might include 512 chirps that each have a slightly different frequency modulation. However, a radar cycle may include more (e.g., 1024) or less (e.g., 256) chirps. By successively transmitting multiple chirps within each radar cycle, the radar system 100 can gather detailed information about the position and movement of objects within the radar system's 100 field of view (FOV).

The central compute cluster 104 may house the receiver 106, the memory 116, and other processing capabilities not shown (e.g., ADAS stack) that can be used to further analyze one or more of the range FFTs or Doppler FFT generated using the radar accelerator logic 110. In other words, the central compute cluster 104 may be responsible for receiving the raw radar data and performing high-level processing and management of radar data, integrating various functions to optimize performance and efficiency. These various functions can include advanced signal processing techniques such as Direction of Arrival (DoA) estimation, tracking algorithms, and object classification.

Direction of Arrival (DoA) estimation may determine the angle at which a radar signal is received. In embodiments where the radar system 100 is implemented in an automotive setting, DoA estimation may allow the radar system 100 to accurately locate objects around the vehicle. By knowing the direction from which signals are coming, the ADAS stack can create a precise map of the vehicle's surroundings, identifying the location of other vehicles, pedestrians, and obstacles.

Tracking algorithms can be used to monitor the movement of detected objects over time. These algorithms can help predict the future positions of objects based on their current speed and trajectory. This capability may be applied to the environment within which the radar system 100 is implemented. For example, tracking algorithms may facilitate adaptive cruise control within an automotive application, where the vehicle is to maintain a safe distance from the car ahead, and for collision avoidance systems that react to sudden changes in the environment around the vehicle.

Object classification can involve identifying and categorizing detected objects. For example, characteristics of the range FFTs or Doppler FFT of each radar cycle can help the radar system 100 distinguish between a pedestrian, a bicycle, and another vehicle. This classification can help the ADAS stack make informed decisions about how to respond to different types of objects. For instance, the ADAS may cause the vehicle to slow down if a pedestrian is detected crossing the road.

According to embodiments, the central compute cluster 104 can house a host processing device (not shown) that can perform these higher level functions and/or operations related to the ADAS stack (if the radar system 100 is integrated within an automotive environment). This host processing device can be any combination of different types of processing devices. The host processing device can include one or more of a central processing unit (CPU), a graphics processing unit (GPU), a digital signal processor (DSP), a field-programmable gate array (FPGA), an application-specific integrated circuit (ASIC), a system on chip (SoC), a neural processing unit (NPU), a tensor processing unit (TPU), a microcontroller (MCU), a quantum processing unit (QPU), or the like. According to embodiments, the host processing device may have access to range FFTs and/or Doppler FFTs stored within the memory 116 by the receiver 106. The host processing device may use the range FFTs and/or Doppler FFTs to perform higher-level functions, such as the DoA estimation, tracking, or object classification as described herein.

The receiver 106 may integrate the radar accelerator logic 110 closely with the interface 108 and intermediate buffer 112 such that raw radar data of a transmission sequence (chirp) is not transferred to the memory 116 via a DMA engine 114 before being processed into a range FFT. The receiver 106 may receive the raw radar data from the radar heads 102 via the interface 108 and may send processed outputs (e.g., range FFTs, Doppler FFTs) to the memory 116 via the one or more DMA engines 114. The receiver 106 may include logic that coordinates the data flow and processing steps between the interface 108, the intermediate buffer 112, the radar accelerator logic 110, the one or more DMA engines 114, and the memory 116.

As used herein, in order for the radar accelerator logic 110 to be “closely integrated” with the interface 108, a connection between the radar accelerator logic 110 and the interface 108 is to exist within the receiver 106. Here, this connection may be the data stream from the interface 108 to the intermediate buffer 112 to the radar accelerator logic 110. This connection, or, “close integration,” can ensure that raw radar data received from the radar heads 102 over the interface 108 is processed directly into range FFTs without the need for intermediate transfers to the memory 116. In other words, the radar accelerator logic 110 is embedded within the receiver 106 in such a way that it can immediately access (e.g., via the intermediate buffer 112) and process the raw radar data as it arrives from the radar heads 102. In practical terms, this means that the intermediate buffer 112 temporarily holds the raw radar data from a transmission sequence, but instead of transferring this data to the memory 116 for processing, the radar accelerator logic 110 processes it directly within the receiver 106. This direct processing eliminates the need for data transfer via a DMA engine 114, thereby reducing latency and improving processing efficiency.

By processing the raw radar data into range FFTs immediately upon receipt, the radar system 100 can quickly convert time-domain radar samples (raw radar data) into frequency-domain data (range FFTs), which can then be used for downstream processes, such as determining the distance of detected objects or to generate a Doppler FFT. This streamlined processing of raw radar data into range FFTs not only enhances the speed and efficiency of radar data processing but also minimizes the load on the DMA engines 114 and memory 116 as well as reduces overall system complexity.

The receiver 106 can be implemented in various hardware configurations. According to embodiments, the receiver 106 may be an integrated circuit (IC) that integrates at least the interface 108, the intermediate buffer 112, the hardware accelerator logic 110, and the one or more DMA engines 114. In one example, the receiver 106 may be implemented as a System on Chip (SoC), which integrates all components, including the radar accelerator logic 110, the interface 108, the intermediate buffer 112, and the one or more DMA engines 114, onto a single chip. This compact design can help reduce latency and power consumption while enhancing data processing speed. In at least some cases, SoCs can be advantageous due to their ability to handle complex processing tasks within a small footprint.

In another example, the receiver 106 may be implemented as an Application-Specific Integrated Circuit (ASIC). In general, ASICs are custom-designed chips typically tailored to perform specific functions with maximum efficiency. In another example, the receiver 106 may be implemented as a Field-Programmable Gate Array (FPGA). FPGAs are reconfigurable chips that can be programmed to perform various functions, including radar data processing. Notwithstanding these three examples (SoC, ASIC, FPGA), the receiver 106 may be implemented in any hardware configuration suitable to be included in the central compute cluster 104 part of the radar system 100 as described herein.

The interface 108 may be configured to receive the raw radar data generated by the radar heads. The interface 108 may be any suitable interface capable of receiving raw radar data. In at least some embodiments, the interface 108 may handle interleaved data from multiple radar heads 102. Here, the interface 108 may include metadata inherent to the related protocol (e.g., Ethernet or CSI) that helps identify and sort the raw radar data from each radar head 102. Once sorted, the interface 108 may store the received raw radar data within the intermediate buffer 112 according to each respective radar head 102.

The interface 108 in the radar system 100 may encompass a variety of interface circuitry designed to handle the reception and/or initial processing (e.g., sorting) of raw radar data from multiple radar heads 102 based on the selected configuration (e.g., Ethernet or CSI). This interface circuitry can include high-speed data receivers or transceivers capable of supporting protocols such as Ethernet or Camera Serial Interface (CSI), which facilitate the rapid transfer of raw radar data. Additionally, the interface 108 may incorporate multiplexers and demultiplexers to manage and route data streams from multiple radar heads 102, which may help ensure that each data stream from each radar head 102 is correctly identified and directed to the appropriate processing path. Error detection and correction circuitry may also be included to ensure data integrity upon reception. Furthermore, the interface circuity may include clock and data recovery circuits to synchronize the incoming data streams, as well as buffers and FIFO (First-In-First-Out) queues to temporarily store data and manage data flow. In at least some embodiments, these buffers or queues may be the intermediate buffer 112. These components of interface circuitry may work together to provide the interface 108 that integrates the radar heads 102 with components of the receiver 106, such as the radar accelerator logic 110 and the intermediate buffer 112.

The intermediate buffer 112, integrated within the receiver 106 alongside the interface 108 and radar accelerator logic 110, may be configured to temporarily store the received raw radar data. In other words, the intermediate buffer 112 only temporarily stores raw radar samples until they are processed by the radar accelerator logic 110. According to embodiments, the intermediate buffer 112 may provide a staging area where the raw radar data can be held until an entire radar transmit sequence (e.g., one chirp) is received from a respective radar head 102. Once raw radar data corresponding to an entire radar transmit sequence is stored within the intermediate buffer, this raw radar data may be processed by the radar accelerator logic 110 into a range FFT and may be discarded from the intermediate buffer 112 or kept for an additional processing pipeline step (like averaging) and discarded later. The intermediate buffer 112 may be configured in any suitable manner capable of temporarily storing the received raw radar data corresponding to one or more radar heads 102. The intermediate buffer 112 may be implemented using, for example, a dual-port SRAM (Static Random Access Memory), on-chip cache, one or more FIFO queues, one or more ring buffers, one or more ping-pong buffers, a register file, a dedicated on-chip RAM block, any combination thereof, or the like. A storage size of the intermediate buffer 112 may be determined based on various characteristics of the radar system 100, such as the number of radar heads 102, how many radar samples are generated for each entire transmit sequence, or the like. However, the storage size of the intermediate buffer 112 may be minimized in order to save space, reduce overall memory footprint, and simplify layout constraints on the receiver 106. In various embodiments, the storage size of the intermediate buffer can vary from several kilobytes (e.g., 4 KB) to several megabytes (e.g., 8 MB).

The intermediate buffer 112 may be configured to store raw radar data from multiple different radar heads 102. This configuration may allow the intermediate buffer 112 to temporarily hold the incoming radar data from various radar heads 102 before they are respectively processed by the radar accelerator logic 110. When raw radar data is received from multiple radar heads via the interface 108, the intermediate buffer 112 (or the interface 108) can utilize metadata inherent to the protocol (such as Ethernet or CSI) to identify and sort the data from each radar head. This metadata can help the intermediate buffer 112 to correctly allocate and store the raw radar data according to its source. For example, raw radar data from a first radar head might be stored in one section of the intermediate buffer 112, while raw radar data from a second radar head may be stored in another section. This organized storage can help ensure that the radar accelerator logic 110 can efficiently access and process the raw radar data from each radar head without confusion or data loss.

The radar accelerator logic 110 may be configured to generate range FFTs using the received raw radar data. The radar accelerator logic 110 may be referred to as radar processing circuitry. In some embodiments, the radar accelerator logic 110 may also be configured to generate Doppler FFTs using the range FFTs generated using the received raw radar data. The radar accelerator logic 110 may include software, firmware, hardware, or any combination thereof. In one embodiment, the radar accelerator logic 110 may include a radar-specific hardware accelerator that includes fixed-function or semi-programmable digital logic blocks designed for pipelined processing of radar data. Here, the radar accelerator logic 110 may include one or more of an FFT block, a windowing unit, a data formatter, a dedicated buffer interface (e.g., that interfaces with the intermediate buffer 112), or the like. These blocks may be commonly supported by control registers that manage transmit sequence (chirp) boundaries, FFT size, memory addressing, or the like. Upon receiving raw radar data for a transmit sequence, the radar accelerator logic 110 may apply a preloaded window function to the raw radar data using a multiplier array. The windowed radar data may then be passed to the FFT block, which may be implemented in any suitable manner (e.g., radix-2, radix-4). In some embodiments, the radar accelerator logic 110 may include bit-reversal logic, scaling modules, or magnitude calculations blocks to streamline the generation of range-domain power spectra.

In other embodiments, the radar accelerator logic 110 may include a digital signal processing (DSP) engine. Here, the radar accelerator logic 110 may include a core designed for high-throughput, low-latency arithmetic operations on complex-valued data. This core can include multiply-accumulate (MAC) units, complex multipliers, vectorized arithmetic logic units (ALUs), any combination thereof, or the like. The core may also include SIMD (single-instruction, multiple-data) instruction sets tailored for signal processing tasks. Here, to transform raw radar data into range FFTs, the radar accelerator logic 110 may first retrieve the raw radar data corresponding to a transmit sequence from the intermediate buffer 112. The radar accelerator logic 110 may then apply a window function (e.g., Hamming or Blackman) to this raw radar data to reduce spectral leakage. Once windowed, the radar accelerator logic 110 can execute the Fourier transform (e.g., via radix-2 or radix-4 Cooley-Tukey FFT algorithms) to generate a range spectrum. This range spectrum may represent the magnitude and phase of reflected signals across various delay bins (ranges). The radar accelerator logic 110 may further normalize the FFT results, apply log-magnitude conversion (e.g., dB scaling), and store the results for subsequent processing, such as Doppler or angle estimation. The resulting set of radar data may be a range FFT.

In at least one embodiment, the radar accelerator logic 110 may include one or more graphics processing units (GPUs), tensor processing units (TPUs), or any other processing device used for processing acceleration of the raw radar data. According to embodiments, such processing device(s) may be used in combination with any hardware accelerator or DSP engine. In at least one embodiment, such processing device(s) may be used to generate range FFTs and/or Doppler FFTs using the raw radar data.

The one or more DMA engines 114 may be used to write radar data processed by the radar accelerator logic 110 (e.g., range FFTs) into memory. The one or more DMA engines 114 may also be used to retrieve this radar data for further processing by the radar accelerator logic 110 (e.g., to generate Doppler FFTs).

The memory 116 can act as the storage unit for processed outputs like range FFTs for chirps or Doppler FFTs for each radar cycle. The memory 116 can provide a repository where the final results can be accessed later for further analysis or integration into the ADAS stack. The memory 116 can be implemented using various types of memory technologies to suit different performance and capacity needs. These include SRAM, DRAM (Dynamic Random-Access Memory), non-volatile memory types such as NAND flash or NOR flash, any combination thereof, or the like. The memory 116 may be implemented according to various other configurations, as described herein.

According to embodiments, the radar system 100 may perform a series of actions in order to generate a Doppler FFT for a radar cycle. First, the radar heads 102 generate raw radar data. The raw data may be in the form of radar samples, or analog-to-digital (ADC) samples. These samples represent reflections from objects detected by the radar waves emitted by the transmitting radar heads of the radar system 100.

Second, the raw radar data generated by the radar heads 102 is received by receiver 106 at the interface 108. The interface 108 may act as a conduit that helps ensure that the raw radar data is temporarily stored within the intermediate buffer 112.

Third, the received raw radar data is temporarily stored in the intermediate buffer 112. The intermediate buffer 112 may hold the raw radar data until an entire radar transmit sequence (e.g., one chirp) is received. By storing the data temporarily, the intermediate buffer 112 can help prevent bottlenecks and ensure smooth and continuous data flow between the radar heads 102 and the receiver 106.

Fourth, the received radar data for the entire radar transmit sequence is processed by the radar accelerator logic 110 to generate a range FFT. This may be referred to as an initial processing phase. This initial processing phase may also include windowing and statistical analysis of the raw radar data.

Fifth, the processed range FFTs are written to memory 116 by the one or more DMA engines 114. In one embodiment, a first DMA engine may write the processed range FFTs to the memory 116.

Sixth, once all raw radar data of a radar cycle has been processed into range FFTs and stored in the memory 116, these range FFTs are retrieved from the memory 116 by the one or more DMA engines 114 and further processed into a Doppler FFT using the radar accelerator logic 110. In one embodiment, a second DMA engine different from the first DMA engine may be used to retrieve these range FFTs from the memory 116. The Doppler FFT can provide information about the velocity of detected objects, enhancing the ability of the radar system 100 to track and analyze moving targets.

Seventh, the Doppler FFT may then be written to the memory 116 and analyzed or otherwise processed by other components or processes of the central compute cluster 104 (e.g., DoA estimation, tracking algorithms, object classification). In some embodiments, the Doppler FFT may be written to the memory 116 using the same DMA engine 114 (first DMA engine) as was used to write the range FFTs to the memory 116. In another embodiment, a different DMA engine 114 may be used to write the Doppler FFT to the memory 116.

FIG. 1B illustrates the radar system 100 implemented within an automotive application, according to one embodiment. As illustrated, the radar system 100 is integrated into a vehicle to provide environmental sensing capabilities used for advanced driver-assistance systems (ADAS). The radar heads 102 are strategically positioned around the vehicle, including the front, rear, and sides, to facilitate a comprehensive or adequate field of view (FOV). These radar heads 102 may be responsible observing return signals corresponding to emitted radar waves that have reflected from objects in the vehicle's surroundings. The raw radar data generated by these radar heads 102 (e.g., radar samples, analog-to-digital (ADC) samples) may then be transmitted to the receiver 106 located within the vehicle. In one embodiment, the raw radar data may be transmitted to the receiver 106 using Ethernet technologies or techniques. In another embodiment, the raw radar data may be transmitted to the receiver 106 using CSI technologies or techniques.

As illustrated, the central compute cluster 104 houses the receiver 106, which may be implemented as a media access controller (MAC) or a camera serial interface (CSI), depending on the specific configuration. However, in at least some embodiments, the receiver 106 may be external to the central compute cluster 104 and interface with the memory 116 of the central compute cluster 104. The receiver 106 may be closely integrated with the central compute cluster 104.

In the context of an automotive environment, the radar system 100 can perform several functions to enhance vehicle safety and performance. One of these functions, DoA estimation, can allow the radar system 100 to accurately determine the angle at which radar signals are received, enabling the ADAS stack to create a precise map of the vehicle's surroundings. Another of these functions, tracking algorithm(s), can monitor the movement of detected objects over time, predicting their future positions based on their current speed and trajectory. Yet another of these functions, object classification, can further enhance the ADAS stack's decision-making capabilities by distinguishing between different types of objects, such as pedestrians, bicycles, and other vehicles.

While FIG. 1B illustrates the radar system 100 in an automotive application, the radar system 100 may be implemented in various other fields where multiple radar heads are connected to a central compute cluster. In aviation, the radar system 100 can be used to enhance situational awareness and collision avoidance by providing real-time data on the position and movement of other aircraft, weather patterns, and obstacles. In the locomotive industry, the radar system can improve safety and efficiency by monitoring track conditions and/or detecting obstacles. Additionally, the radar system 100 can be applied in maritime navigation to detect and track other vessels, buoys, and potential hazards, thereby enhancing navigational safety. Other potential applications include industrial automation, where radar can monitor the movement of machinery and materials, and security systems, where it can detect and track intruders in large areas.

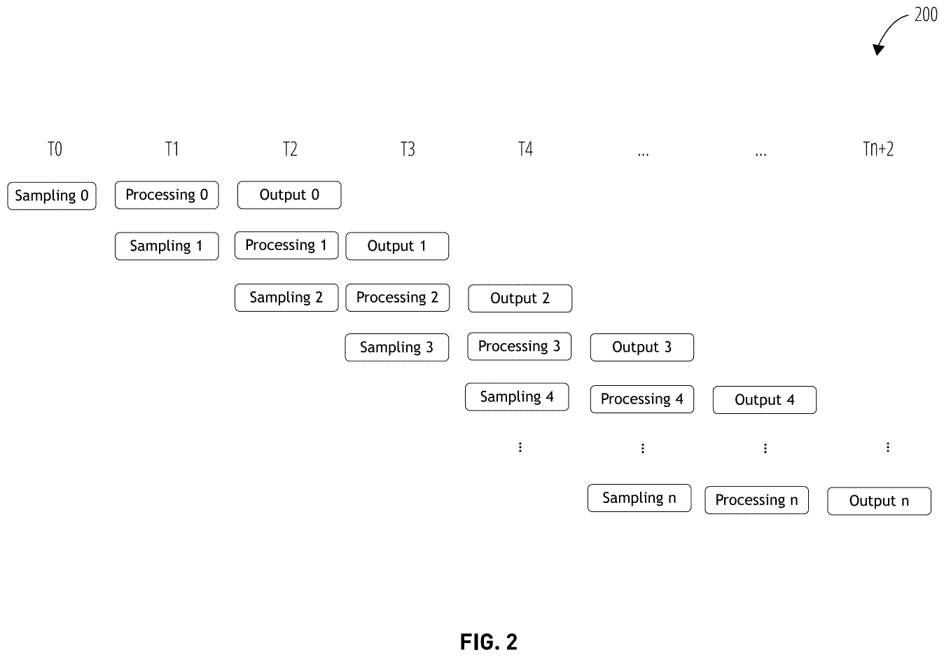

FIG. 2 illustrates a processing pipeline 200 for generating range FFTs using radar accelerator logic integrated within a receiver, such as the radar accelerator logic 110, according to one embodiment. The processing pipeline 200 may be implemented by hardware, software, firmware, or a combination thereof. In at least one embodiment, the processing pipeline 200 is performed by processing logic comprising hardware, software, firmware, or a combination thereof. The processing logic may include one or more processing devices one or more computing devices, one or more hardware accelerators, or other electronic devices as described herein. According to embodiments, the processing logic may include some or all of radar system 100 as described above with respect to FIG. 1A and FIG. 1B. In some embodiments, the processing logic may be comprised of multiple processing devices. Alternatively, the processing pipeline 200 can be performed by other devices.

The processing pipeline 200 may include a systematic sequence of steps designed to transform raw radar data into refined range FFTs through various stages of processing without writing the raw radar data to memory. In the context of the radar system 100, the processing pipeline 200 handles the continuous flow of raw radar data generated by the radar heads 102 and generates range FFTs without writing the raw radar data to the memory 116. This processing pipeline 200 can involves capturing raw radar data and temporarily storing it in an intermediate buffer (sampling), processing it into range FFTs using radar accelerator logic (processing), and finally writing the processed data to memory (output). By organizing these steps into a streamlined sequence of stages, these steps can be performed concurrently.

At T0, the processing logic begins by generating Sampling 0, which is the raw radar data for the first received transmission sequence (chirp). This raw radar data is captured by the radar heads 102 and then transmitted to the receiver 106 via the interface 108. The intermediate buffer 112 within the receiver 106 temporarily stores this raw radar data, ensuring that it is held securely until it is ready for processing by the radar accelerator logic 110.

At T1, the radar accelerator logic 110 processes Sampling 0, the raw radar data stored in the intermediate buffer 112. The radar accelerator logic 110 generates Output 0, which may be a range FFT. Concurrently, Sampling 1 is generated, which is the raw radar data for a second received transmission sequence.

At T2, the processed output, Output 0 (range FFT) corresponding to Sampling 0, is written to memory 116 via the DMA engine 114. Concurrently, the processing pipeline 200 continues to operate, and the radar accelerator logic 110 processes Sampling 1 to generate Output 1. Additionally, Sampling 2 is generated (raw radar data for the third received transmission sequence) and stored in the intermediate buffer 112, ready for the next processing cycle.

At T3, the processing pipeline 200 continues with multiple operations occurring simultaneously. Output 1 (range FFT) is written to memory 116, the radar accelerator logic 110 processes Sampling 2 to generate Output 2, and Sampling 3 is generated (raw radar data for the fourth received transmission sequence) and stored in the intermediate buffer 112.

The processing pipeline 200 may continue in a cyclical manner until all raw radar data for a radar cycle is received and processed. At each subsequent time step (T4, T5, T6, and so on), the processing pipeline 200 handles multiple operations concurrently: writing the processed output (range FFT) of the previous set of raw radar data to memory, processing the current set of raw radar data to generate the next range FFT, and generating and storing the next raw radar data for the next transmission sequence. This ensures a continuous and efficient flow of data through the system. This pipeline continues until raw radar data of every transmission sequence of the radar cycle has been processed. Here, as illustrated, Tn+2 processing cycles are completed, where Tn represents the total number of transmission sequences in the radar cycle. By the end of this process, all raw radar data for the entire radar cycle has been received, processed into range FFTs, and stored in memory, ready for further processing (e.g., generating a Doppler FFT) or analysis.

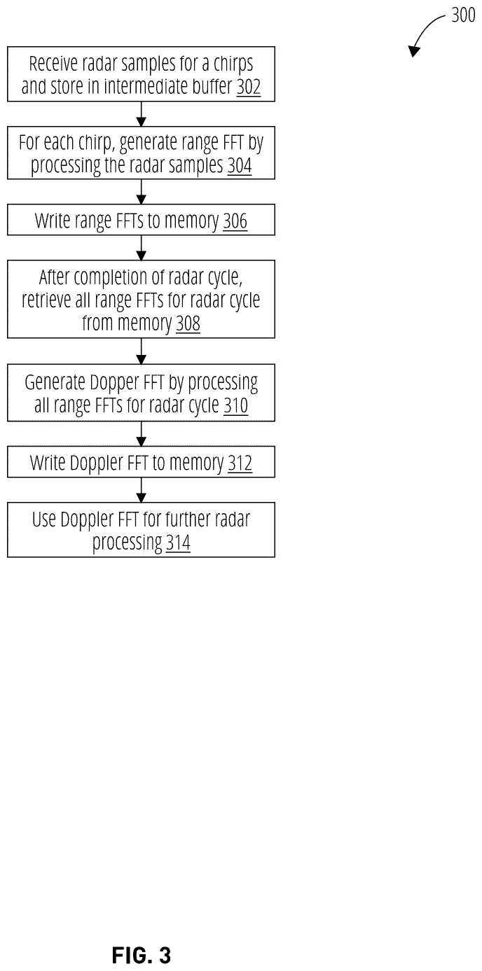

FIG. 3 illustrates a method 300 for generating range FFTs without writing raw radar data to memory, according to one embodiment. The method 300 may be implemented by hardware, software, firmware, or a combination thereof. In at least one embodiment, the method 300 is performed by processing logic comprising hardware, software, firmware, or a combination thereof. The processing logic may include one or more processing devices one or more computing devices, one or more hardware accelerators, or other electronic devices as described herein. According to embodiments, the processing logic may include some or all of radar system 100 as described above with respect to FIG. 1A and FIG. 1B. In some embodiments, the processing logic may be comprised of multiple processing devices. Alternatively, the method 300 can be performed by other devices.

At block 302, the processing logic may receive radar samples for a series of chirps and store these samples in an intermediate buffer. This may involve capturing raw data from radar signals, which are typically reflected off objects and received by the radar system. Here, the radar heads 102 may generate these radar samples, which are then transmitted to the receiver 106 via the interface 108. The intermediate buffer 112 temporarily holds this data before further processing, ensuring that the raw radar data is securely stored and readily available for the next stage of processing.

At block 304, the processing logic may generate range FFTs by processing the radar samples stored in the intermediate buffer. This can involve converting the time-domain raw radar data into frequency-domain data to determine the distance of objects from the radar system based on the time delay of reflected signals. Here, the radar accelerator logic 110 may optionally apply a window function to the raw radar data to reduce spectral leakage and then perform the FFT to generate the range FFT.

At block 306, the processing logic may write the generated range FFTs to memory. This step involves storing the processed frequency-domain data in a memory unit, such as memory 116, for subsequent retrieval and analysis. Here, a first DMA engine may facilitate this transfer.

At block 308, after the completion of a radar cycle, the processing logic may retrieve all range FFTs for the radar cycle from memory. Here, a second DMA engine may retrieve the stored range FFTs from memory 116.

At block 310, the processing logic may generate a Doppler FFT for the radar cycle by processing all range FFTs retrieved from memory. Doppler FFTs are used to determine the relative velocity information of detected objects based on changes in frequency due to motion. Here, the radar accelerator logic 110 may process the range FFTs to compute the Doppler FFT, which can provide insights into the speed and direction of moving objects.

At block 312, the processing logic may write the generated Doppler FFT to memory. Similar to the previous storage step at block 306, this can involve saving the processed velocity information in a memory unit, such as memory 116, for future use or analysis. The first DMA engine (or a different DMA engine) may facilitate this transfer. By storing the Doppler FFT, the processing logic preserves the processed data, making it available for further analysis and integration into higher-level applications, such as DoA estimation, tracking, and/or object classification.

At block 314, the processing logic may use the Doppler FFT for further radar processing. This final step involves utilizing both distance and velocity information derived from previous steps to perform advanced tasks such as object detection, tracking, and classification within the radar system. In embodiments where the processing logic is integrated within an automotive application, the ADAS stack can leverage the Doppler FFT to make real-time decisions, enhancing situational awareness and vehicle safety. For example, the processing logic may be capable of identifying and tracking moving objects, predicting their future positions, and/or classifying them as pedestrians, vehicles, or other obstacles.

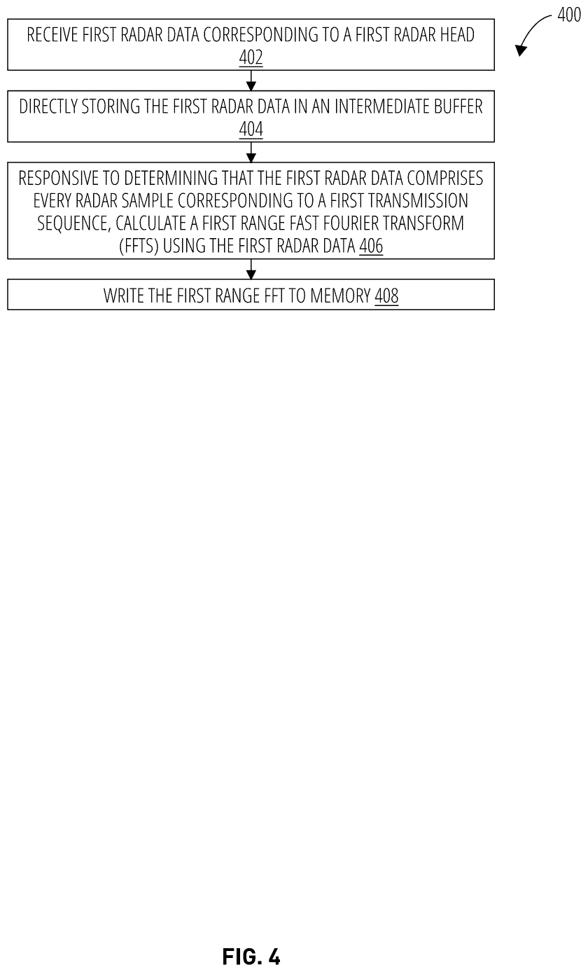

FIG. 4 illustrates a method 400 of generating range FFTs without writing raw radar data to memory, according to one embodiment. The method 400 may be implemented by hardware, software, firmware, or a combination thereof. In at least one embodiment, the method 400 is performed by processing logic comprising hardware, software, firmware, or a combination thereof. The processing logic may include one or more processing devices one or more computing devices, one or more hardware accelerators, or other electronic devices as described herein. According to embodiments, the processing logic may include some or all of radar system 100 as described above with respect to FIG. 1A and FIG. 1B. In some embodiments, the processing logic may be comprised of multiple processing devices. Alternatively, the method 400 can be performed by other devices.

At block 402, the processing logic may receive first radar data corresponding to a first radar head. This radar data is not written to memory directly. Instead, at block 404, the processing logic may directly store the first radar data in an intermediate buffer.

At block 406, the processing logic may calculate a first range FFT using the first radar data. The processing logic performs this calculation responsive to determining that the first radar data includes every radar sample corresponding to a first transmission sequence.

At block 408, the processing logic may write the first range FFT to memory.

After the first range FFT is written to memory, the processing logic may retrieve the first range FFT from memory. Then, the first range FFT, along with other range FFTs of the same radar cycle, may be used to calculate a Doppler FFT. The calculated Doppler FFT may then be written to memory. The Doppler FFT may only be written after each range FFT of the radar cycle has been computed or otherwise calculated.

In some embodiments, the first range FFT and the Doppler FFT may be written to memory via a first direct memory access (DMA) engine. The first range FFT is retrieved from memory via a second DMA engine different from the first DMA engine. In another embodiment, the first range FFT may be retrieved by the same first DMA engine.

According to embodiments, the processing logic may also process second radar data corresponding to a second radar head. The processing logic may receive second radar data and directly store it in the intermediate buffer, similar to the first radar data. The processing logic may then calculate a second range FFT using the second radar data responsive to determining that the second radar data includes every radar sample corresponding to a second transmission sequence. The second range FFT is then written to memory. After the second range FFT is written to memory, the processing logic may retrieve the second range FFT from memory at a later time (e.g., after all range FFTs corresponding to a radar cycle of the second radar head have been processed and stored in memory). Then, the second range FFT, along with other range FFTs of the same radar cycle, may be used to calculate a second Doppler FFT. The second Doppler FFT may then be written to memory.

In at least some embodiments, radar heads (e.g., the first radar head and the second radar head) are integrated within a vehicle and positioned to provide radar information according to different fields of view (FOVs) relative to the vehicle. This configuration can allow the vehicle to gather comprehensive radar data from multiple perspectives, enhancing situational awareness and safety.

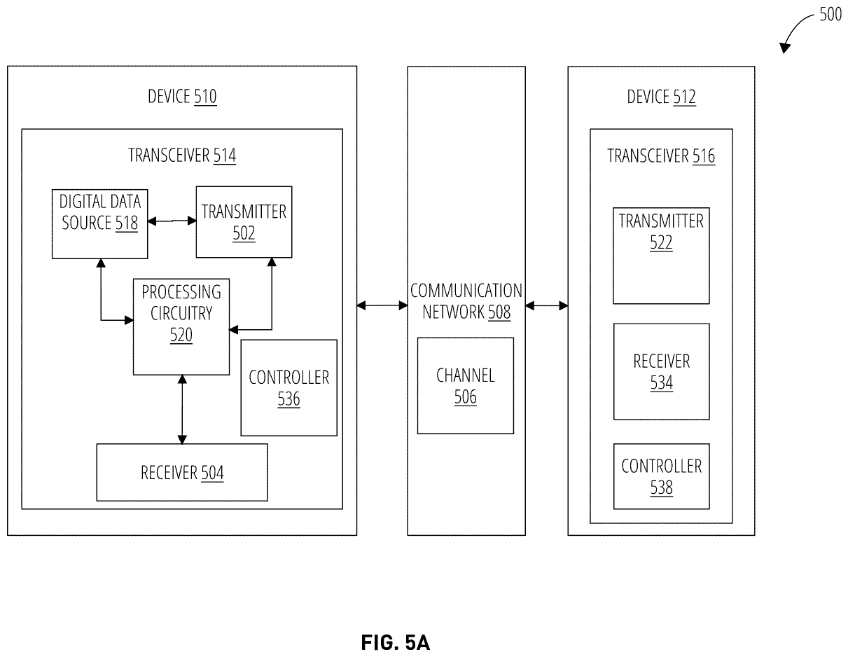

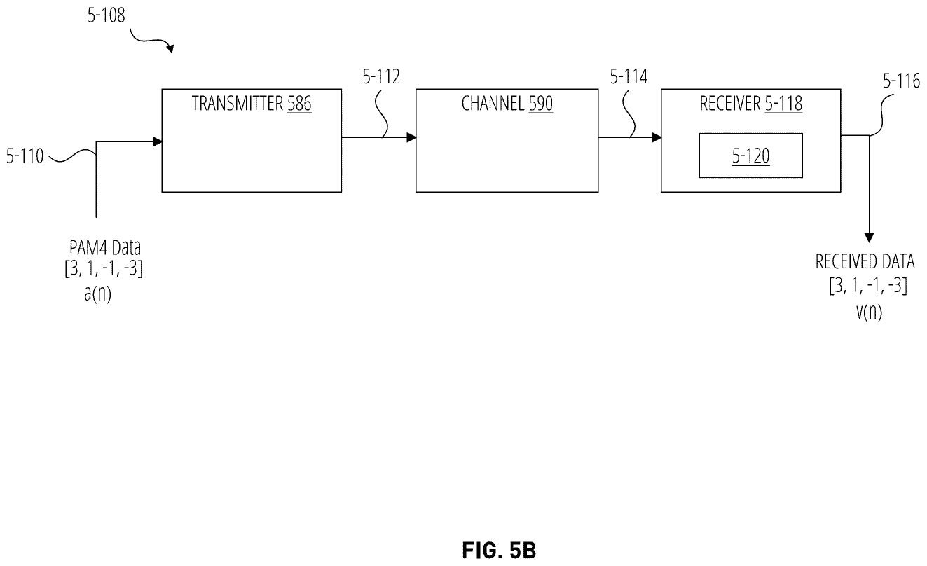

FIG. 5A illustrates an example communication system 500 with a controller 536, in accordance with at least some embodiments. The communication system 500 includes a device 510, a communication network 508 including a communication channel 506, and a device 512. In at least one embodiment, the device 510 may be the central compute cluster 104 and the device 512 may be one of the radar heads 102 of the radar system 100 as described herein with respect to at least FIG. 1A and FIG. 1B. In at least one embodiment, the devices 510 and 512 are integrated circuits of a Personal Computer (PC), a laptop, a tablet, a smartphone, a server, a collection of servers, or the like. In some embodiments, the devices 510 and 512 may correspond to any appropriate type of device that communicates with other devices also connected to a common type of communication network 508. According to embodiments, the transmitter 502 and 522 of devices 510 or 512 may correspond to transmitters of a Graphics Processing Unit (GPU), a switch (e.g., a high-speed network switch), a network adapter, a central processing unit (CPU), a data processing unit (DPU), etc.

Examples of the communication network 508 that may be used to connect the devices 510 and 512 include wires, conductive traces, bumps, terminals, optical fibers, or the like. In other embodiments, the communication network 508 can be a Peripheral Component Interconnect Express (PCIe) interconnect. PCIe is a high-speed interface standard used to connect various hardware components. It can be an interconnect for devices such as graphics cards (GPUs), solid-state drives (SSDs), network cards, and other peripherals. PCIe offers a scalable, high-speed, and point-to-point connection between devices, including CPUs, GPUs, memory, and the like. In other embodiments, the communication network 508 can be a high-speed interconnect, such as an interconnect that deploys the NVLink technology. The NVLink interconnect can be a GPU-GPU interconnect used between GPUs, a CPU-GPU interconnect between GPUs and CPUs, or an interconnect used between other devices. NVLink offers a higher bandwidth and lower latency than traditional PCIe connections, which are typically used in computing hardware. NVLink is especially useful in scenarios that require massive parallel processing, such as artificial intelligence (AI), machine learning, deep learning, high-performance computing (HPC), and data analytics. For example, in NVIDIA's DGX systems and high-end gaming or AI workstations, NVLink helps GPUs exchange data at speeds that are necessary for demanding tasks like real-time ray tracing or training neural networks. In one specific, but non-limiting example, the communication network 508 is a network that enables data transmission between the devices 510 and 512 using data signals (e.g., digital, optical, wireless signals), clock signals, or both. The embodiments described herein can be utilized in a system with a high-speed, scalable switch, such as a switch using the NVSwitch technology. NVSwitch is a high-speed, scalable switch developed by NVIDIA that facilitates data communication between multiple GPUs in a system, allowing them to work together more efficiently by providing high-bandwidth, low-latency interconnections. The NVSwitch serves as a central hub or high-bandwidth fabric that interconnects all the GPUs in a system, enabling each GPU to communicate with every other GPU quickly and efficiently. The NVSwitch can be coupled between other types of devices, such as CPUs, accelerators, memory, or the like. The NVSwitch can be used for tasks requiring intense computation and collaboration between multiple GPUs, such as AI model training, scientific simulations, and large-scale data processing. The embodiments described herein can be used in a high-performance computing system, such as a computing system modeled after NVIDIA's DGX systems, which are designed specifically for artificial intelligence (AI), deep learning, and high-performance computing (HPC) workloads. DGX systems are optimized for large-scale GPU computation and parallel processing, integrating multiple GPUs, high-bandwidth interconnects, and software frameworks tailored for AI and HPC tasks. In at least one embodiment, a system for high-speed network communication includes a processing unit, a network interface comprising a receiver or transceiver with the controller. In at least one embodiment, a system for high-speed network communication includes a processing unit, a network interface comprising a receiver or transceiver with controller or other processing device to optimize LT processes, as described herein. The processing unit can include a CPU, a GPU, a DPU, a network adapter, a network switch, an NVLink switch, or the like. Other examples for the communication network 508 can include other chip-to-chip or die-to-die interconnects, such as GRS, LPI (low power interface) or LLI (low latency interface).

The device 510 includes a transceiver 514 for sending and receiving signals, for example, data signals. The data signals may be digital or optical signals modulated with data or other suitable signals for carrying data.

The transceiver 514 may include a digital data source 518, a transmitter 2402, a receiver 504, and processing circuitry 520 that controls the transceiver 514. The digital data source 518 may include suitable hardware and/or software for outputting data in a digital format (e.g., in binary code and/or thermometer code). The digital data output by the digital data source 518 may be retrieved from memory (not illustrated) or generated according to input (e.g., user input).

The transceiver 514 includes suitable software and/or hardware for receiving digital data from the digital data source 518 and outputting data signals according to the digital data for transmission over the communication network 508 to a transceiver 516 of device 512.

The receiver 504 of device 510 may include suitable hardware and/or software for receiving signals, for example, data signals from the communication network 508. For example, the receiver 504 may include components for receiving processing signals to extract the data for storing in a memory. In at least one embodiment, the transceiver 516 includes a transmitter 522 and receive 534. The transceiver 516 receives an incoming signal and samples the incoming signal to generate samples, such as using an analog-to-digital converter (ADC). The ADC can be controlled by a clock-recovery circuit (or clock recovery block) in a closed-loop tracking scheme. The clock-recovery circuit can include a controlled oscillator, such as a voltage-controlled oscillator (VCO) or a digitally-controlled oscillator (DCO) that controls the sampling of the subsequent data by the ADC.

The processing circuitry 520 may include software, hardware, or a combination thereof. For example, the processing circuitry 520 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 520 may include hardware, such as an Application-Specific Integrated circuit (ASIC). Other non-limiting examples of the processing circuitry 520 include an Integrated Circuit (IC) chip, a CPU, A GPU, a DPU, a microprocessor, a Field-Programmable Gate Array (FPGA), a collection of logic gates or transistors, resistors, capacitors, inductors, diodes, or the like. Some or all of the processing circuitry 520 may be provided on a Printed Circuit Board (PCB) or collection of PCBs. It should be appreciated that any appropriate type of electrical component or collection of electrical components may be suitable for inclusion in the processing circuitry 520. The processing circuitry 520 may send and/or receive signals to and/or from other elements of the transceiver 514 to control the overall operation of the transceiver 514.

The transceiver 514 or selected elements of the transceiver 514 may take the form of a pluggable card or controller for the device 510. For example, the transceiver 514 or selected elements of the transceiver 514 may be implemented on a network interface card (NIC).

The device 512 may include a transceiver 516 for sending and receiving signals, for example, data signals over a channel 506 of the communication network 508. The channel 2406 can be PCIe, NVLink, Ethernet, InfiniBand, Ground Reference Signal (GRS), Chip-to-Chip (C2C), Die-to-Die (D2D), or the like. The same or similar structure of the transceiver 514 may be applied to transceiver 516, and thus, the structure of transceiver 516 is not described separately.

Although not explicitly shown, it should be appreciated that devices 510 and 512 and the transceiver 514 and transceiver 516 may include other processing devices, storage devices, and/or communication interfaces generally associated with computing tasks, such as sending and receiving data.

FIG. 5B illustrates a block diagram of an example communication system 5-108 employing a receiver 5-118 with a controller 5-120, according to at least one embodiment. In the example shown in FIG. 5B, a Pulse Amplitude Modulation level-4 (PAM4) modulation scheme is employed with respect to the transmission of a signal (e.g., digitally encoded data) from a transmitter (TX) 586 to a receiver (RX) 5-118 via a communication channel 590 (e.g., a transmission medium). The communication channel 590 can be PCIe, NVLink, Ethernet, InfiniBand, GRS, C2C, D2D, or the like. In this example, the transmitter 586 receives an input data 5-110 (i.e., the input data at time n is represented as “a(n)”), which is modulated in accordance with a modulation scheme (e.g., PAM4) and sends the signal 5-112a(n) including a set of data symbols (e.g., symbols −3, −1, 1, 3, where the symbols represent coded binary data). It is noted that while the use of the PAM4 modulation scheme is described herein by way of example, other data modulation schemes can be used in accordance with embodiments of the present disclosure, including for example, a non-return-to-zero (NRZ) modulation scheme, PAM3, PAM7, PAM8, PAM16, etc. For example, for an NRZ-based system, the transmitted data symbols consist of symbols −1 and 1, with each symbol value representing a binary bit. This is also known as a PAM level-2 or PAM2 system as there are 2 unique values of transmitted symbols. Typically, a binary bit 0 is encoded as −1, and a bit 1 is encoded as 1 as the PAM2 values.

In the example shown, the PAM4 modulation scheme uses four (4) unique values of transmitted symbols to achieve higher efficiency and performance. The four levels are denoted by symbol values −3, −1, 1, 3, with each symbol representing a corresponding unique combination of binary bits (e.g., 00, 01, 10, 11).

The communication channel 590 is a destructive medium in that the channel acts as a low pass filter which attenuates higher frequencies more than it attenuates lower frequencies, introduces inter-symbol interference (ISI) and noise from cross talk, from power supplies, from Electromagnetic Interference (EMI), or from other sources. The communication channel 590 can be over serial links (e.g., a cable, PCB traces, copper cables, optical fibers, or the like), read channels for data storage (e.g., hard disk, flash solid-state drives (SSDs), high-speed serial links, deep space satellite communication channels, applications, or the like. The receiver (RX) 5-118 receives an incoming signal 5-114 over the channel 590. The receiver 5-118 can output a received signal 5-116, “v(n),” including the set of data symbols (e.g., symbols −3, −1, 1, 3, wherein the symbols represent coded binary data).

In at least one embodiment, the transmitter 586 can be part of a SerDes IC. The SerDes IC can be a transceiver that converts parallel data to serial data and vice versa. The SerDes IC can facilitate transmission between two devices over serial streams, reducing the number of data paths, wires/traces, terminals, etc. The receiver 5-118 can be part of a SerDes IC. The SerDes IC can include a clock-recovery circuit. The clock-recovery circuit can be coupled to an ADC and an equalization block. In another embodiment, the SerDes IC can include additional equalization block before a symbol detector.

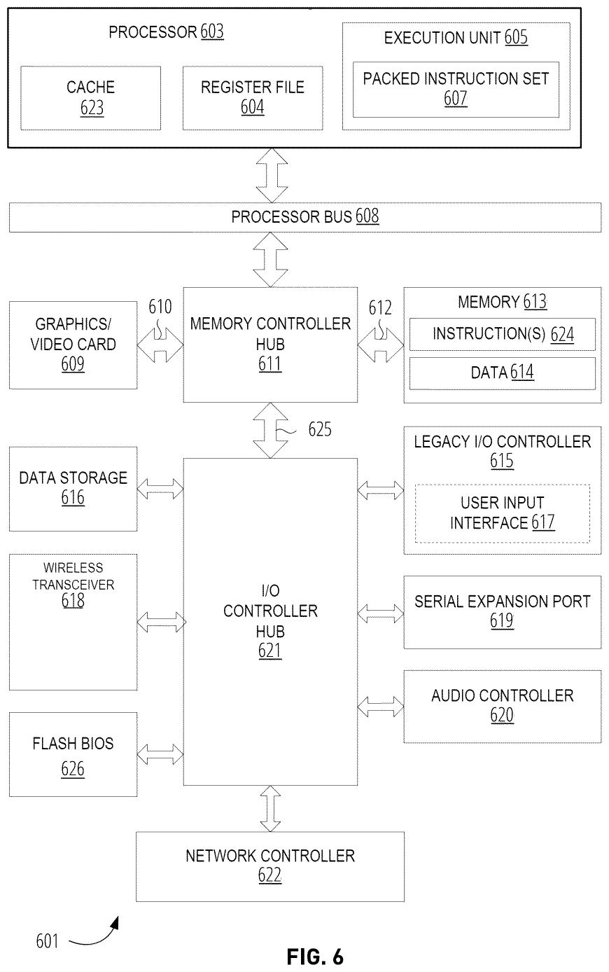

FIG. 6 illustrates an example computer system 601, in accordance with at least some embodiments. In at least one embodiment, computer system 601 may be a system with interconnected devices and components, an SOC, or some combination. In at least one embodiment, the computer system 601 may be part of the central compute cluster 104 as described with respect to the radar system 100 of FIG. 1A or FIG. 1B. In at least one embodiment, computer system 601 is formed with a processor 603 that may include execution units to execute an instruction. In at least one embodiment, computer system 601 may include, without limitation, a component, such as a processor 603, to employ execution units including logic to perform algorithms for processing data. In at least one embodiment, computer system 601 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 601 may execute a version of WINDOWS' operating system available from Microsoft Corporation of Redmond, Wash., although other operating systems (UNIX and Linux, for example), embedded software, and/or graphical user interfaces, may also be used.

In at least one embodiment, computer system 601 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 601 may be used in devices such as graphics processing units (GPUs), network adapters, central processing units, and network devices such as switches (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 601 may include, without limitation, processor 603 that may include, without limitation, one or more execution units 605 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 601 is a single processor desktop or server system. In at least one embodiment, computer system 601 may be a multiprocessor system. In at least one embodiment, processor 603 may include, without limitation, a CISC microprocessor, a RISC microprocessor, a VLIW microprocessor, and a processor implementing a combination of instruction sets, or any other processor device, such as a digital signal processor, for example. In at least one embodiment, processor 603 may be coupled to a processor bus 608 that may transmit data signals between processor 603 and other components in computer system 601.

In at least one embodiment, processor 603 may include, without limitation, a Level 1 (“L1”) internal cache memory (“cache”) 623. In at least one embodiment, processor 603 may have a single internal cache or multiple levels of internal cache. In at least one embodiment, cache memory may reside externally to processor 603. In at least one embodiment, processor 603 may also include a combination of both internal and external caches. In at least one embodiment, a register file 604 may store different types of data in various registers including, without limitation, integer registers, floating point registers, status registers, and instruction pointer register.

In at least one embodiment, execution unit 605, including, without limitation, logic to perform integer and floating point operations, also resides in processor 603. Processor 603 may also include a microcode (“ucode”) read only memory (“ROM”) that stores microcode for certain macro instructions. In at least one embodiment, execution unit 605 may include logic to handle a packed instruction set 607. In at least one embodiment, by including packed instruction set 607 in an instruction set of a general-purpose processor 603, along with associated circuitry to execute instructions, operations used by many multimedia applications may be performed using packed data in a general-purpose processor 603. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, execution unit 606 may also be used in microcontrollers, embedded processors, graphics devices, DSPs, and other types of logic circuits. In at least one embodiment, computer system 601 may include, without limitation, a memory 613. In at least one embodiment, memory 613 may be implemented as a DRAM device, an SRAM device, flash memory device, or other memory devices. Memory 613 may store instruction(s) 624 and/or data 614 represented by data signals that may be executed by processor 603.

In at least one embodiment, a system logic chip may be coupled to a processor bus 608 and memory 613. In at least one embodiment, the system logic chip may include, without limitation, a memory controller hub (“MCH”) 611, and processor 603 may communicate with MCH 611 via processor bus 608. In at least one embodiment, MCH 611 may provide a high bandwidth memory path 612 to memory 613 for instruction and data storage and for storage of graphics commands, data, and textures. In at least one embodiment, MCH 611 may direct data signals between processor 603, memory 613, and other components in computer system 601 and may bridge data signals between processor bus 608, memory 613, and a system I/O 625. In at least one embodiment, a system logic chip may provide a graphics port for coupling to a graphics controller. In at least one embodiment, MCH 611 may be coupled to memory 613 through high bandwidth memory path 612, and graphics/video card 609 may be coupled to MCH 611 through an Accelerated Graphics Port (“AGP”) interconnect 610.

In at least one embodiment, computer system 601 may use system I/O 625 that is a proprietary hub interface bus to couple MCH 611 to I/O controller hub (“ICH”) 621. In at least one embodiment, ICH 621 may provide direct connections to some I/O devices via a local I/O bus. In at least one embodiment, a local I/O bus may include, without limitation, a high-speed I/O bus for connecting peripherals to memory 613, a chipset, and processor 603. Examples may include, without limitation, an audio controller 620, a firmware hub (“flash BIOS”) 726, a wireless transceiver 618, a data storage 616, a legacy I/O controller 615 containing a user input interface 617, a keyboard interface, a serial expansion port 619, such as a USB, and a network controller 622. In at least one embodiment, the network controller 622 includes the error correction circuit 630. Data storage 616 may include a hard disk drive, a floppy disk drive, a CD-ROM device, a flash memory device, or other mass storage device. In at least one embodiment, the data storage 616 may be the memory 116 as described with respect to the radar system 100.

In at least one embodiment, FIG. 6 illustrates a system, which includes interconnected hardware devices or “chips.” In at least one embodiment, FIG. 6 may illustrate an example SoC. In at least one embodiment, devices illustrated in FIG. 6 may be interconnected with proprietary interconnects, standardized interconnects (e.g., PCIe), or some combination thereof. In at least one embodiment, one or more components of system 602 are interconnected using compute express link (“CXL”) interconnects.

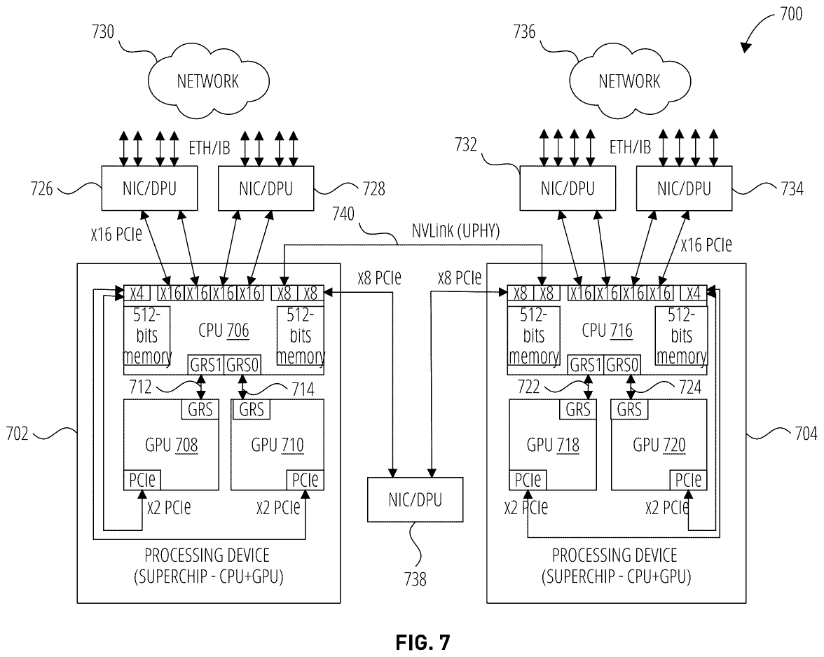

FIG. 7 is a block diagram of a computing system 700 having two processing devices coupled to each other and multiple networks according to at least one embodiment. The computing system 700 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 700. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 700 highly suitable for demanding applications that require significant processing power, such as artificial intelligence (AI), machine learning (ML), and data-intensive computing, while ensuring robust connectivity and scalability across various networked environments. The integrated circuits of the computing system 700 can include one or more CPUs and one or more GPUs. An example architecture of a multi-GPU architecture is illustrated in FIG. 7. In at least some embodiments, the processing device 702 and/or processing device 704 may be part of the central compute cluster 104 of the radar system 100 as described herein.

As illustrated in FIG. 7, the computing system 700 includes a processing device 702 with a multi-GPU architecture. In particular, the processing device 702 includes a CPU 706, a GPU 708, and a GPU 710. The CPU 706 can be coupled to the GPU 708 via an die-to-die (D2D) or chip-to-chip (C2C) interconnect 712, such as a Ground-Referenced Signaling interconnect (GRS interconnect). The CPU 706 can be coupled to the GPU 710 via a D2D or C2C interconnect 714. The CPU 706 can also be coupled to the GPU 708 and GPU 710 via PCIe interconnects. The CPU 706 can be coupled to one or more network interface cards (NICs) or data processing units (DPUs), which are coupled to one or more networks. For example, as illustrated in FIG. 7, the CPU 706 is coupled to a first NIC/DPU 726, which is coupled to a network 730. The CPU 706 is also coupled to a second NIC/DPU 728, which is coupled to the network 730. The NIC/DPU 726 and NIC/DPU 728 can be coupled to the network 730 over Ethernet (ETH) or InfiniBand (IB) connections.

The computing system 700 also includes a processing device 704 with a multi-GPU architecture. In particular, the processing device 704 includes a CPU 716, a GPU 718, and a GPU 720. The CPU 716 can be coupled to the GPU 718 via an D2D or C2C interconnect 722. The CPU 716 can be coupled to the GPU 720 via a D2D or C2C interconnect 724. The CPU 716 can also be coupled to the GPU 718 and GPU 720 via PCIe interconnects. The CPU 716 can be coupled to one or more NICs or DPUs, which are coupled to one or more networks. For example, as illustrated in FIG. 7, the CPU 716 is coupled to a first NIC/DPU 732, which is coupled to a network 736. The CPU 716 is also coupled to a second NIC/DPU 734, which is coupled to the network 736. The NIC/DPU 732 and NIC/DPU 734 can be coupled to the network 736 over Ethernet (ETH) or InfiniBand (IB) connections. In at least one embodiment, one or more of the NIC/DPU 726, NIC/DPU 728, NIC/DPU 732, or NIC/DPU 734 may connect to one or more radar heads 102 as described with respect to the radar system 100.

In at least one embodiment, the processing device 702 and the processing device 704 can communicate with each other via a NIC/DPU 738, such as over PCIe interconnects. The processing device 702 and processing device 704 can also communicate with each other over a high-bandwidth communication interconnects 740, such as an NVLink interconnect or other high-speed interconnects. The NIC/DPUs of FIG. 7 can be the various embodiments of the DPUs described herein.

In at least one embodiment, the computing system 700 is used for high-speed network communication and includes a processing unit (e.g., CPU 706, GPU 708, GPU 710, CPU 716, GPU 718, GPU 720, NIC/DPU 726, NIC/DPU 728, NIC/DPU 732, NIC/DPU 734, or NIC/DPU 738), and a network interface coupled to the processing unit. The network interface can include the operations and functionality of the DPUs described herein.

In at least one embodiment, the computing system 700 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

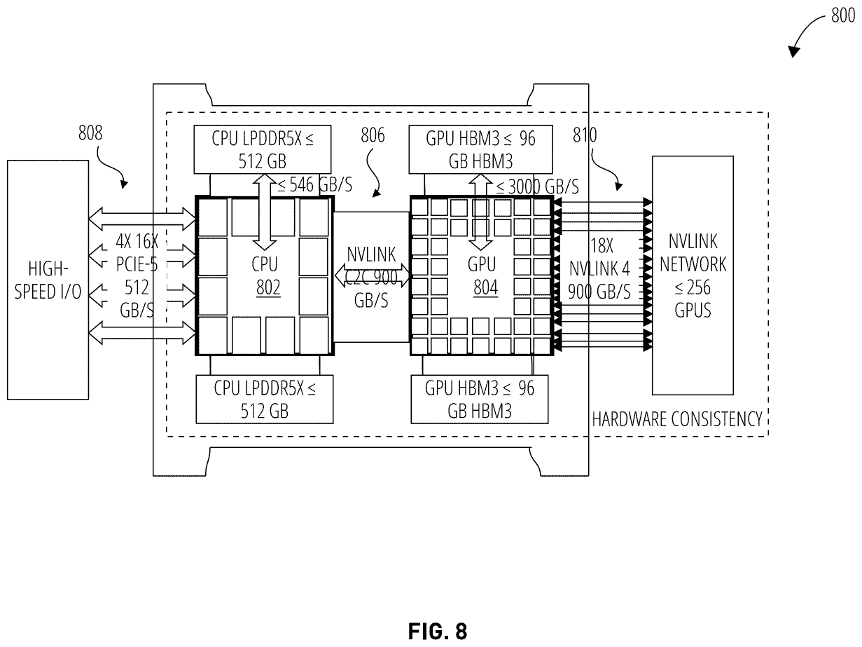

FIG. 8 is a block diagram of a computing system 800 having a CPU 802 and a GPU 804 in a single integrated circuit according to at least one embodiment. The computing system 800 can be a highly integrated design where a CPU 802 and GPU 804 are connected on a single integrated circuit, utilizing an NVLink C2C (Chip-to-Chip) interconnect 806 to enable fast, low-latency communication between the two processing units. In at least one embodiment, the computing system 800 may be part of the central compute cluster 104 as described with respect to the radar system 100. This close integration allows for efficient data transfer and parallel processing between the CPU 802 and GPU 804, optimizing performance for complex computational tasks. The GPU elements within the computing system 800 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 810. Additionally, the computing system 800 can be designed to interface with a high-speed I/O through PCIe interconnects 808, ensuring rapid data transfer to and from external devices, further enhancing the system's capabilities in handling data-intensive tasks and providing robust connectivity to peripheral components. It should be noted that the C2C interconnects 806 can be considered D2D interconnects since the CPU 802 and the GPU 804 are located on the same integrated circuit. The integrated circuit can include CPU memory (also referred to as main memory) and GPU memory, which are accessible by the CPU 802 and the GPU 804, respectively, over high-speed interconnects. The computing system 800 can bring together performance of the GPU 804 with the versatility of the CPU 802. The CPU 802 can be connected with a high-bandwidth and memory coherent C2C interconnects 806 in a single integrated circuit. The computing system 800 can support a link switch system.

In at least one embodiment, the computing system 800 is used for high-speed network communication and includes a processing unit, and a network interface coupled to the processing unit. The network interface can include the operations and functionality of the DPUs described herein.

In at least one embodiment, the computing system 800 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

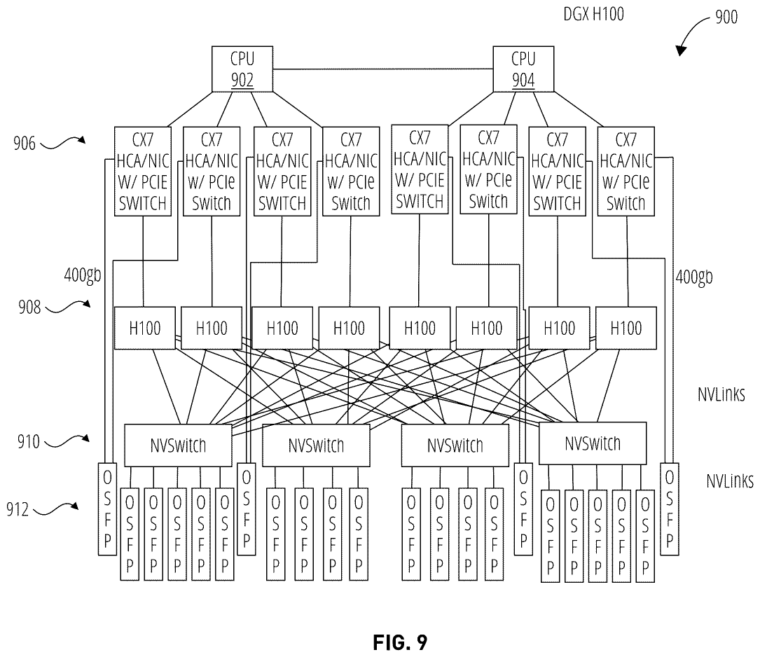

FIG. 9 is a block diagram of a computing system 900 having tensor core GPUs 908 according to at least one embodiment. The computing system 900 can be a DGX H100 system, which is a high-performance computing platform designed to meet the demands of AI, ML, and deep learning (DL) workloads. The computing system 900 can include multiple tensor core GPUs 908 (e.g., NVIDIA H100 Tensor Core GPUs). The tensor core GPUs 908 can be optimized for AI/ML/DL applications, offering exceptional performance for deep learning training, inference, and high-performance computing tasks. The tensor core GPUs 908 within the computing system 900 are interconnected using high-speed communication interfaces like NVLinks, enabling rapid data transfer between them, which is crucial for handling large-scale AI models and datasets with low latency. This computing system 900 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 908, the computing system 900 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 908 for their specific applications. The computing system 900 is ideally suited for large-scale AI model training, real-time inference, scientific simulations, data analytics, and other compute-intensive tasks that require massive parallel processing power.

The tensor core GPUs 908 can be coupled to multiple CPUs, such as CPU 902 and CPU 904, using switches 906 (e.g., CX7 HCA/NIC with PCIe switch). The tensor core GPUs 908 can be coupled to each other via switches 910 (e.g., NVSwitches). The switches 906 and switches 910 can be coupled to high-speed transceiver modules 912. The high-speed transceiver modules 912 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 900 remains capable of meeting increasing data demands and can be upgraded to support future advancements in network speeds, thus contributing to the system's overall performance and scalability.

In at least one embodiment, the computing system 900 can be considered a data-network configuration with full-bandwidth intra-server NVLinks. In this example, all eight tensor core GPUs 908 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 908 can half-subscribe eighteen NVLinks to GPUs in other servers. Four tensor core GPUs 908 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 908 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 900 is used for high-speed network communication and includes a processing unit (e.g., CPU 902, CPU 904, switches 906, tensor core GPUs 908, switches 910, high-speed transceiver modules 912), and a network interface coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 900 includes a host device and an auxiliary device. The auxiliary device includes a device memory and a processor, communicably coupled to the device memory. The auxiliary device can include a GPU. The auxiliary device can include a DPU. The auxiliary device can include a DPU. The auxiliary device can include accelerator hardware.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, a set of non-transitory computer-readable storage media includes multiple non-transitory computer-readable storage media and one or more individual non-transitory storage media of multiple non-transitory computer-readable storage media lack all of code while multiple non-transitory computer-readable storage media collectively store all of code. In at least one embodiment, executable instructions are executed such that different instructions are executed by different processors —for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may include one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A radar system comprising:
a first radar sensor unit configured to generate radar data based on observed return signals; and
a central compute cluster comprising:
memory; and
a receiver interfacing the memory to the first radar sensor unit, the receiver comprising:
interface circuitry to receive the radar data from the first radar sensor unit;
radar processing circuitry to process the radar data into a first range fast Fourier transform (FFT); and
one or more direct memory access (DMA) engines to write the first range FFT into the memory.

2. The radar system of claim 1, wherein the radar data is processed into the first range FFT without being written to the memory.

3. The radar system of claim 1, wherein the receiver further comprises:
an intermediate buffer coupled to the interface circuitry to directly receive the radar data from the interface circuitry, wherein the radar processing circuitry is to directly receive the radar data from the intermediate buffer.

4. The radar system of claim 1, wherein the receiver is to:
retrieve the first range FFT from the memory using the one or more DMA engines;
calculate, using the radar processing circuitry, a Doppler FFT using the first range FFT; and
write the Doppler FFT into the memory.

5. The radar system of claim 1, further comprising:
a second radar sensor unit configured to generate second radar data based on observed return signals, wherein the receiver is coupled to the second radar sensor unit, and wherein the interface circuitry is to receive the radar data from the second radar sensor unit, the radar processing circuitry is to process the second radar data into a second range FFT, and the one or more DMA engines are to write the second range FFT into the memory.

6. The radar system of claim 5, wherein the receiver is to:
retrieve the first range FFT from the memory using the one or more DMA engines;
retrieve the second range FFT from the memory using the one or more DMA engines;
calculate, using the radar processing circuitry, a first Doppler FFT using the first range FFT;
calculate, using the radar processing circuitry, a second Doppler FFT using the second range FFT;
write the first Doppler FFT into the memory; and
write the second Doppler FFT into the memory.

7. The radar system of claim 1, wherein the radar system is integrated within a vehicle.

8. The radar system of claim 1, wherein the receiver is a System on Chip (SoC).

9. A circuit comprising:
interface circuitry to receive raw radar data;
an intermediate buffer coupled to the interface circuitry to temporarily store the raw radar data;
radar processing circuitry coupled to the intermediate buffer to process the raw radar data into a first range fast Fourier transform (FFT); and
a direct memory access (DMA) engine to write the range FFT into memory external to the circuit, wherein the memory is associated with a host processing device.

10. The circuit of claim 9, wherein the raw radar data is processed into the range FFT without being written to the memory external to the circuit.

11. The circuit of claim 9, wherein the circuit is to:
retrieve the range FFT from the memory external to the circuit;
calculate a Doppler FFT using the first range FFT; and
write the Doppler FFT into the memory external to the circuit.

12. The circuit of claim 9, wherein the circuit is integrated within a radar system part of a vehicle.

13. The circuit of claim 9, wherein the circuit is a System on Chip (SoC).

14. A method comprising:
receiving first radar data corresponding to a first radar sensor unit;
directly storing the first radar data in an intermediate buffer;
responsive to determining that every radar sample corresponding to a first transmission sequence is stored within the intermediate buffer, calculating a first range fast Fourier transform (FFT) using the first radar data; and
writing the first range FFT to memory.

15. The method of claim 14, wherein the first radar data is not written to the memory.

16. The method of claim 14, further comprising:
retrieving the first range FFT from the memory;
calculating a Doppler FFT using the first range FFT; and
writing the Doppler FFT to the memory.

17. The method of claim 16, wherein the first range FFT and the Doppler FFT are written to the memory via a first direct memory access (DMA) engine, and wherein the first range FFT is retrieved from memory via a second DMA engine.

18. The method of claim 14, further comprising:
receiving second radar data corresponding to a second radar sensor unit;
directly storing the second radar data in the intermediate buffer;
responsive to determining that the second radar data comprises every radar sample corresponding to a second transmission sequence, calculating a second range FFT using the second radar data; and
writing the second range FFT to the memory.

19. The method of claim 18, further comprising:
retrieving the first range FFT from the memory;
retrieving the second range FFT from the memory;
calculating a first Doppler FFT using the first range FFT;
calculating a second Doppler FFT using the second range FFT;
writing the first Doppler FFT to the memory; and
writing the second Doppler FFT to the memory.

20. The method of claim 19, wherein the first radar sensor unit and the second radar sensor unit are each integrated within a vehicle, and wherein the first radar sensor unit and the second radar sensor unit are positioned to provide radar information according to different fields of view (FOVs) relative to the vehicle.
